(19) United States
(12) Patent Application Publication
(10) Pub. No.: US 2009/0032582 A1
(43) Pub. Date: Feb. 5, 2009

(54) INFORMATION PROVIDING APPARATUS, INFORMATION PROVIDING METHOD, AND COMPUTER PRODUCT

(75) Inventors: Hirohisa Naito, Kawasaki (JP); Takahiro Kii, Kawasaki (JP); Toru Ozaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/246,112

(22) Filed: Oct. 6, 2008

Related U.S. Application Data
(63) Continuation of application No. PCT/JP2006/309637, filed on May 15, 2006.

(51) Int. Cl. G06F 17/00

(52) U.S. Cl. 235/380

(57) ABSTRACT

An information providing apparatus provides a menu to a portable terminal and, when an item is selected from the menu by the user of the portable terminal, provides detailed information about the item. The information providing apparatus has an IC-tag reader that corresponds to a menu item and performs short-distance wireless communication with the portable terminal held thereover. Upon receiving, from the portable terminal that has received input information, the input information via the IC-tag reader through short-distance wireless communication, the information providing apparatus performs a predetermined process corresponding to the menu item based on the input information and predetermined identification information.

This is a continuation filed under 35 U.S.C. § 111(a), of International Application No. PCT/JP2006/309637, filed May 15, 2006.

### BACKGROUND OF THE INVENTION

1. Field of the Invention

The present invention relates to a technology for providing information to users.

2. Description of the Related Art

Information has been provided to users through a guideboard or the like; however, in recent years, electronic technology has been used to improve services for providing information.

For example, Japanese Laid-open Patent Publication No. 2005-235166 discloses a technology in which a portable terminal is provided to visitors to an art gallery, a museum, or the like to provide information about exhibits, and an IC tag for guidance placed near an exhibit reads from the portable terminal the age bracket and native language of a visitor to select a suitable description to be provided.

Japanese Laid-open Patent Publication No. 2005-135335 discloses a technology in which a positional relation among a plurality of contactless card readers and services are associated one another so that a user can provide input by a simple operation such as holding a card over a reader.

Japanese Laid-open Patent Publication No. 2005-159958 discloses a technology for reliably and securely obtaining and transmitting information through communication between a communication-purpose terminal placed near a guideboard or advertisement medium and a user terminal carried by the user.

Meanwhile, to perform a more sophisticated process according to guidance to be provided, a user is required to provide input of information. For example, an information providing apparatus that provides travelers with information on accommodation facilities preferably offers a service that provides information about an accommodation facility to a user so that the user can directly make a reservation at that accommodation facility. To make a reservation at an accommodation facility, however, the user is required to provide input of information, such as check-in/-out date and the number of people to stay.

However, in a service using, for example, a guideboard that provides information simultaneously to an indefinite number of users, a difficulty may occur in inputting characters. For example, extra space is required to place an input device, such as a keyboard. Moreover, the service is occupied by a user until that user finishes input operation. This is inefficient because the next user cannot use the service. Furthermore, input information can be viewed by other users.

Also, when a user provides input using an input unit other than a keyboard, such as a touch-panel display, an input operation becomes burdensome and takes a long time until it finishes, and may also be interrupted by an input operation by another user. Moreover, with the use of a touch panel or the like, input information can also be viewed by other users, and this is even more serious due to a long time required for the input operation.

That is, with the conventional technologies, a user cannot be perform input operations collectively in a simplified manner, which decreases convenience and inhibiting improvement in service.

### SUMMARY

It is an object of the present invention to at least partially solve the problems in the conventional technology.

According to an aspect of the present invention, there is provided an information providing apparatus includes: a display unit that displays a predetermined menu item; a process performing unit that performs a predetermined process corresponding to the menu item; and a wireless communicating unit that includes a reader unit corresponding to the menu item. The reader unit receives, from a portable terminal that has received input information necessary for the predetermined process and is brought near the reader unit, the input information together with identification information that identifies a user or the portable terminal through short-distance wireless communication. The process performing unit performs the predetermined process based on the identification information and the input information.

According to another aspect of the present invention, there is provided an information providing apparatus includes: a display unit that displays a predetermined menu item; a connecting unit that establishes a connection to an external server including a process performing unit that performs a predetermined process corresponding to the menu item; and a wireless communicating unit that includes a reader unit corresponding to the menu item. The reader unit receives, from a portable terminal that has received input information necessary for the predetermined process and is brought near the reader unit, the input information together with identification information that identifies a user or the portable terminal through short-distance wireless communication. The connecting unit transmits the identification information and the input information to the external server to cause the process performing unit to perform the predetermined process.

According to still another aspect of the present invention, there is provided an information providing method includes: displaying a predetermined menu item; performing a predetermined process corresponding to the menu item; and communicating via a reader unit corresponding to the menu item with a portable terminal through short-distance wireless communication. The reader unit receives, from the portable terminal that has received input information necessary for the predetermined process and is brought near the reader unit, the input information together with identification information that identifies a user or the portable terminal. The predetermined process is performed based on the identification information and the input information.

According to still another aspect of the present invention, there is provided an information providing method includes: displaying a predetermined menu item; establishing a connection to an external server including a process performing unit that performs a predetermined process corresponding to the menu item; and communicating via a reader unit corresponding to the menu item with a portable terminal through short-distance wireless communication. The reader unit receives, from the portable terminal that has received input information necessary for the predetermined process and is brought near the reader unit, the input information together with identification information that identifies a user or the portable terminal. The connecting includes transmitting the identification information and the input information to the external server to cause the process performing unit to perform the predetermined process.

According to still another aspect of the present invention, there is provided a computer-readable recording medium that stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a concept of an information providing system according to an embodiment of the present invention;

FIG. 2 is a schematic block diagram of the information providing system;

FIG. 3 is a specific example of information provided by an information providing apparatus depicted in FIG. 1;

FIG. 4 is a schematic diagram for explaining a character input to a portable terminal and transmission of input information;

FIG. 5 is a flowchart of the operation of the information providing system;

FIG. 6 is a flowchart of a process of providing an input format from the information providing apparatus to the portable terminal;

FIG. 7 is a flowchart of operation to avoid an operation error due to an interrupt by another user;

FIG. 8 is a is a flowchart of a process of identifying an accommodation facility at the time of transmitting an input format;

FIG. 9 is a flowchart of a process of automatically launching a program for input;

FIG. 10 is a schematic block diagram of an information providing system that provides information about shops and goods;

FIG. 11 is a specific example of information provided by an information providing apparatus depicted in FIG. 10; and

FIG. 12 is a flowchart of a process of managing responses to questionnaires.

### DETAILED DESCRIPTION OF THE PREFERRED EMBODIMENTS

Exemplary embodiments of the present invention are described in detail below with reference to the accompanying drawings.

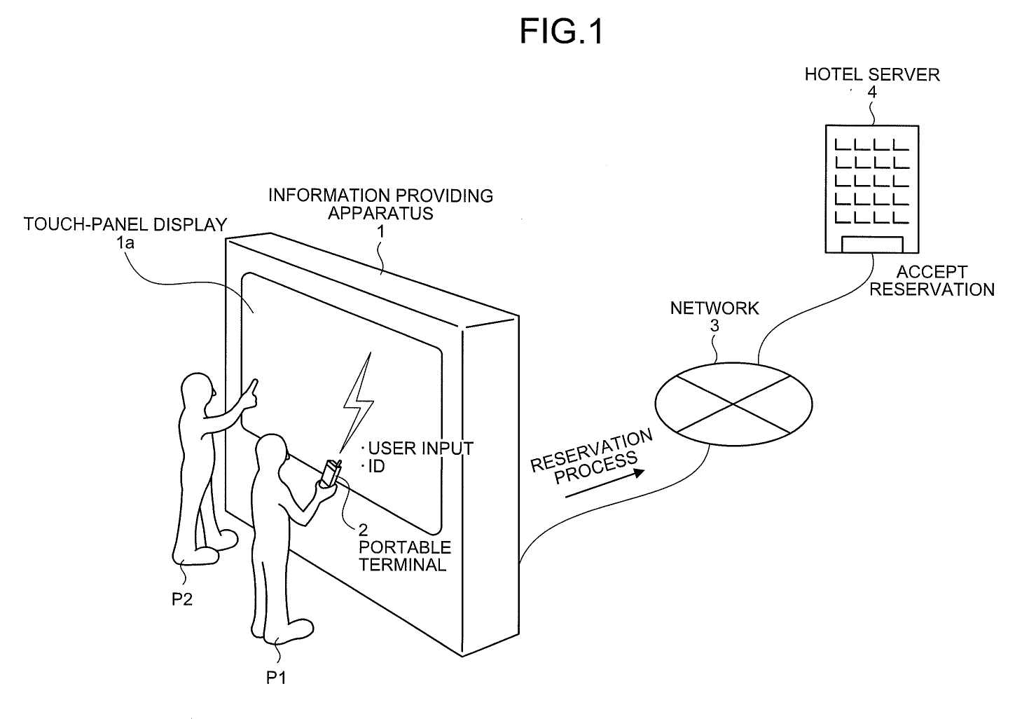

First, a general outline of an embodiment of the present invention is explained with reference to FIG. 1. In FIG. 1, an information providing apparatus 1 is a public apparatus placed in a station, a plaza, or the like to provide information about accommodation facilities and perform a reservation process.

The information providing apparatus 1 displays information about accommodation facilities on a touch-panel display 1a, and provides detailed information about an accommodation facility selected by a user touching the display.

The information providing apparatus 1 has an IC-tag reader to perform short-distance wireless communication with a portable terminal held by the user over the reader. Through this short-distance wireless communication, when a user P1 inputs information, such as check-in/-out date and the number of people to stay, to a portable terminal 2a and then holds the portable terminal over an IC-tag reader corresponding to a menu item for a reservation process to transmit the input information, the information providing apparatus 1 perform a process of making a reservation at the designated accommodation facility based on the input information from the user and predetermined identification information (ID).

The reservation process by the information providing apparatus 1 is a process of transmitting information to a hotel server 4, which is a server of the accommodation facility designated by the user, through a network 3, and is completed by the hotel server 4 accepting a reservation for accommodation from the user P1.

In this manner, with the user P1 inputting necessary information to a portable terminal 2 for transmission from the portable terminal 2 to the information providing apparatus 1 through short-distance wireless communication, the information providing apparatus 1 collectively receives information required for a reservation process. Thus, even if another user P2 operates the touch-panel display 1a, no interrupts occur in information inputs by the user P1.

Since characters are input to the portable terminal, comfortable character input can be achieved without providing any device on the information providing apparatus 1 side for inputting characters. It is further possible to prevent input information from being viewed from other users.

The predetermined identification information may be, for example, a unique number that specifies the portable terminal 2 or a user ID registered in advance by the user P1.

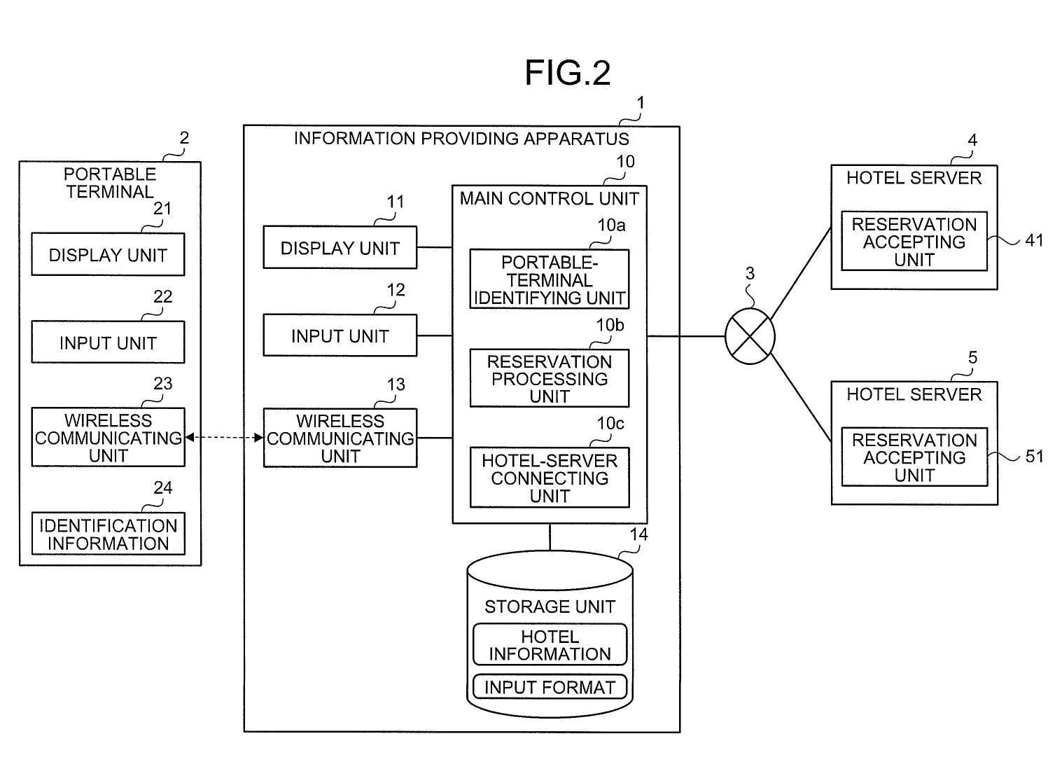

A specific example of configuration of an information providing system is depicted in FIG. 2. In FIG. 2, the information providing system includes the information providing apparatus 1, the portable terminal 2, the network 3, and hotel servers 4 and 5.

The portable terminal 2 is carried and possessed by the user, and includes a display unit 21, an input unit 22, a wireless communicating unit 23, and identification information 24. The display unit 21 can be implemented by, for example, a liquid-crystal display, and the input unit 22 can be implemented by an arbitrary keyboard, switch, or voice input. In the case of voice input, a microphone and a voice recognition function are used.

The wireless communicating unit 23 performs short-distance wireless communication through Radio Frequency Identification (RFID), i.e., IC-tag function. The identification information 24 identifies the portable terminal or the user as explained above. Examples of the identification information 24 include a number unique to the portable terminal 2 (manufacturer's serial number or telephone number), unique information assigned to the wireless communicating unit 23, or a user ID registered in advance by the user P1.

The portable terminal 2 is not necessarily a terminal device dedicated for the present system, and may be a mobile telephone, a game machine, a music player, a Personal Digital Assistant (PDA), or the like.

The information providing apparatus 1 includes a display unit 11, an input unit 12, a wireless communicating unit 13, a storage unit 14, and a main control unit 10. The display unit 11 is implemented by a liquid-crystal display, a plasma display, or a projector, and the input unit 12 is implemented by a touch panel or the like. With this, the display unit 11 and the input unit 12 function as the touch-panel display 1a depicted in FIG. 1.

The wireless communicating unit 13 is an IC-tag reader, and perform a process of reading information input by the user and the identification information 24 by communicating with the wireless communicating unit 23 of the portable terminal 2. The storage unit 14 stores therein information about accommodation facilities, such as hotels and inns, as hotel information, and also an input format for inputting information required for reservation to the portable terminal 2.

The main control unit 10 controls the overall operation of the information providing apparatus 1, such as changing the display contents on the display unit 11 based on the input received by the input unit 12, and includes a portable-terminal identifying unit 10a and a reservation processing unit lob.

The portable-terminal identifying unit 10a obtains the identification information 24 of the portable terminal 2 held over the wireless communicating unit 13 to identify the portable terminal. The reservation processing unit lob performs a reservation process on a designated hotel by using information required for reservation received by the wireless communicating unit 13 from the portable terminal 2 and the identification result from the portable-terminal identifying unit 10a.

A hotel-server connecting unit 10c establishes a connection to the hotel servers 4 and 5 via the network 3 for reservation.

The hotel servers 4 and 5 are used by each accommodation facility in accepting a reservation, including reservation accepting units 41 and 51, respectively, and connected to the information providing apparatus 1 via the network 3.

For example, when the user desires a stay at a hotel where the hotel server 4 is placed, the reservation processing unit lob of the information providing apparatus 1 performs a reservation process by transmitting information required for reservation (check-in/-out date, the number of people, names, or the like) to the hotel server 4.

The hotel servers 4 and 5 may be configured to notify the information providing apparatus 1 that the reservation has been accepted and notify the user through display on the display unit 11 or communication to the portable terminal 2 that the reservation has been completed.

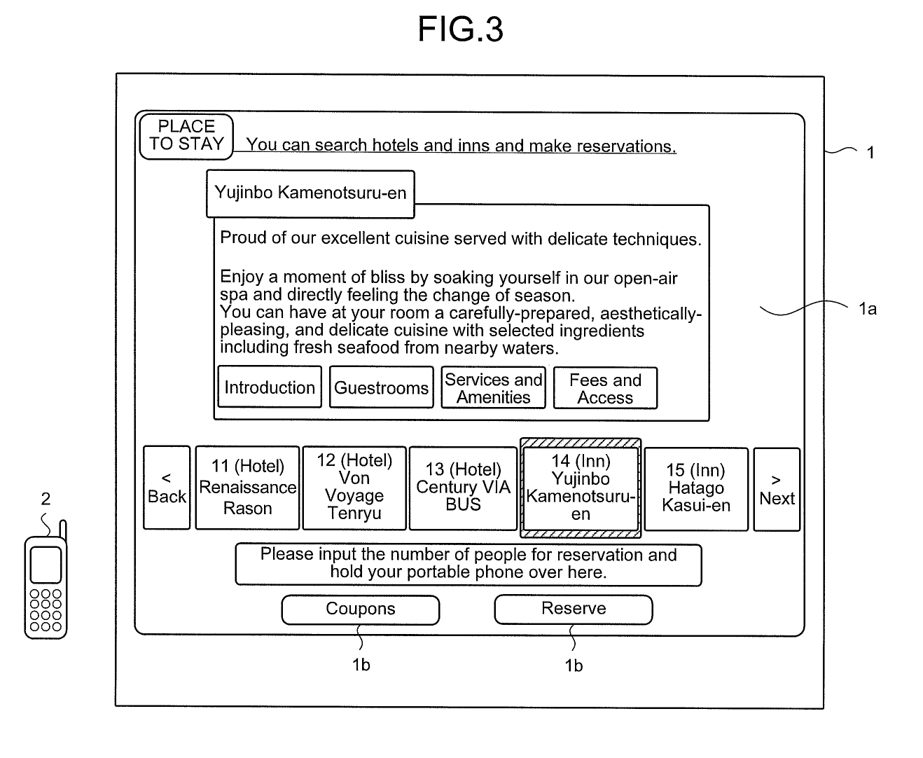

Next, with reference to FIG. 3, a specific example of information provided by the information providing apparatus 1 is explained. In FIG. 3, the touch-panel display 1a displays a list of accommodation facilities, and further, displays detailed information about “Yujinbo Kamenotsuruen”, which is an accommodation facility selected by the user from the list through an operation onto the touch panel.

On a lower portion of the display, a message “Please input the number of people for reservation and hold your portable phone over here.” and a menu including menu items “Coupons” and “Reserve” are displayed. These “Coupons” and “Reserve” are displayed at locations correspondingly to IC-tag readers 1b.

When the user brings the portable terminal near the display of “Coupons” (i.e., when the user holds the portable terminal over the IC-tag reader corresponding to “Coupons”), the user can receive discount information or the like from the information providing apparatus 1. When the user brings the portable terminal near the display of “Reserve” (i.e., when the user holds the portable terminal over the IC-tag reader corresponding to “Reserve”), a reservation process can be performed.

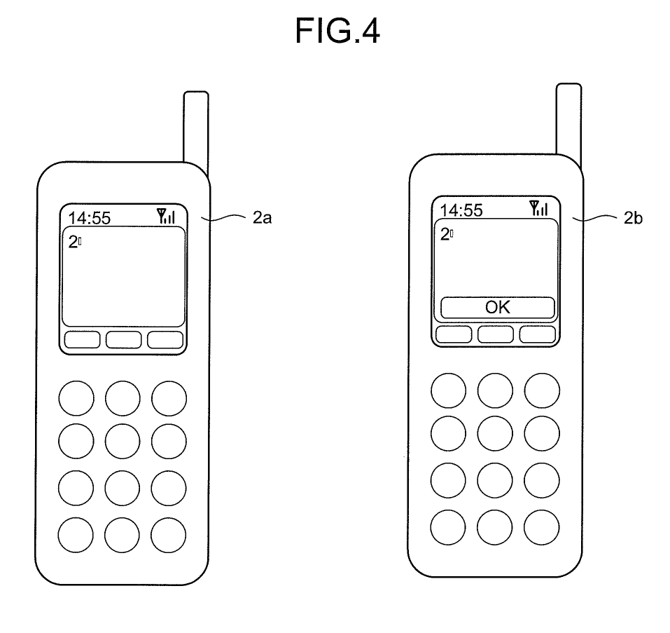

A character input to the portable terminal and transmission of input information are explained with reference to FIG. 4. In an input example 2a depicted in FIG. 4, when the user inputs a number “2” as the number of people for reservation and holds the portable phone over the wireless communicating unit (reader unit) of the information providing apparatus 1, the input is transmitted to the information providing apparatus 1. That is, the content displayed on the screen is input directly through the wireless communicating unit.

In an input example 2b, a number “2” input by the user as the number of people for reservation is temporarily stored in an IC card area of the portable phone by pressing an “OK” button. Then, when the user holds the portable phone over the reader unit, the input is transmitted to the information providing apparatus 1. With this, even when the screen makes a transition to another screen, the information input to the portable phone is input to the information providing apparatus 1 when the portable phone is held over the reader unit.

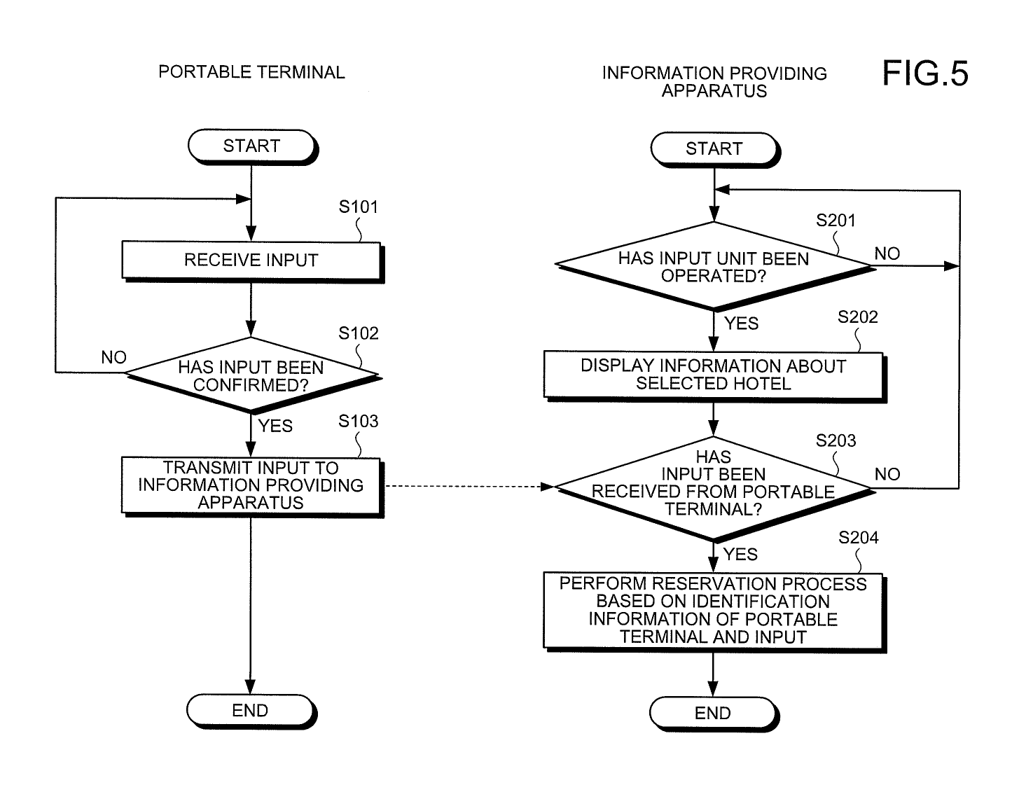

The operation of the information providing system to transmit information input by the user as appropriate in the manner described above is explained with reference to FIG. 5. As depicted in FIG. 5, the portable terminal 2 receives input from the user through the input unit 22 (Step S101). If the input has been confirmed (Yes at Step S102), the portable terminal 2 is held over or brought near the information providing apparatus to carry out a wireless communication and transmit the input to the information providing apparatus (Step S103).

On the other hand, if the input unit 12 has been operated (Yes at Step S201), the information providing apparatus 1 displays detailed information about a hotel (accommodation facility) selected through the operation (Step S202).

Upon receiving identification information and the input from the portable terminal (Yes at Step S203), the information providing apparatus 1 performs a reservation process of the accommodation facility based on the received identification information and the input (Step S204), and the process ends.

In addition to the number of people to stay, the information required for accommodation-facility reservation include, for example, check-in/-out date. Thus, when information is transmitted from the portable terminal 2 to the information providing apparatus 1, a plurality of pieces of necessary information may be collectively transmitted.

When such a plurality of pieces of necessary information are collectively transmitted, it is preferable that the user provide input according to a predefined format. If a defined input format is stored by the information providing apparatus 1 in the storage unit 14 as an input format and is transmitted to the portable terminal 2 before the user provides input, user operation can be simplified.

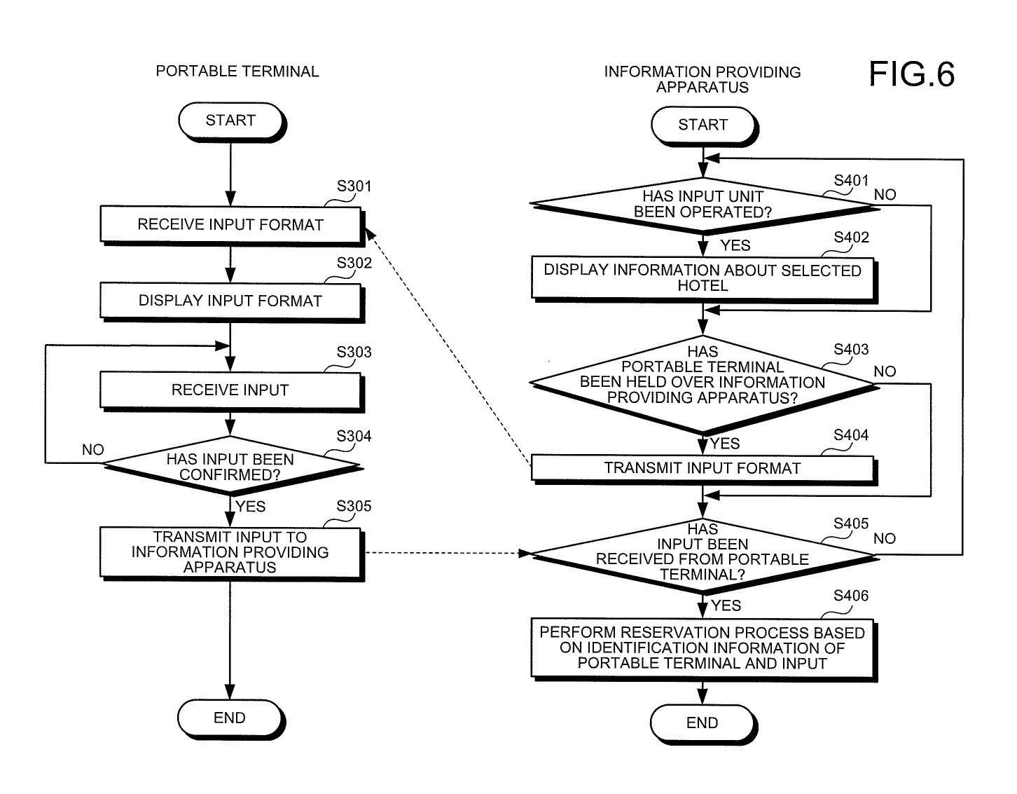

FIG. 6 is a flowchart of a process of providing an input format from the information providing apparatus 1 to the portable terminal 2. In FIG. 6, upon receiving an input format from the information providing apparatus 1 through short-distance wireless communication (Step S301), the portable terminal 2 displays the input format on the display unit 21 (Step S302).

Then, the portable terminal 2 receives input provided from the user by using the input format (Step S303), performs an input confirmation process (Yes at Step S304). When brought near to perform a wireless communication, the portable terminal 2 transmits the input to the information providing apparatus (Step S305).

On the other hand, the information providing apparatus 1 first determines whether the input unit 12 has been operated (Step S401). If the input unit 12 has been operated (Yes at Step S401), the information providing apparatus 1 displays detained information about a hotel (accommodation facility) selected through the operation (Step S402).

The information providing apparatus 1 also determines whether the portable terminal 2 has been held thereover (Step S403). If the portable terminal 2 has been held thereover (Yes at Step S403), the information providing apparatus 1 transmits the input format to the portable terminal 2 (Step S404).

If the identification information and the input are received from the portable terminal (Yes at Step S405), the information providing apparatus 1 performs a process of making a reservation at the accommodation facility based on the received identification information and the input (Step S406), and the process ends.

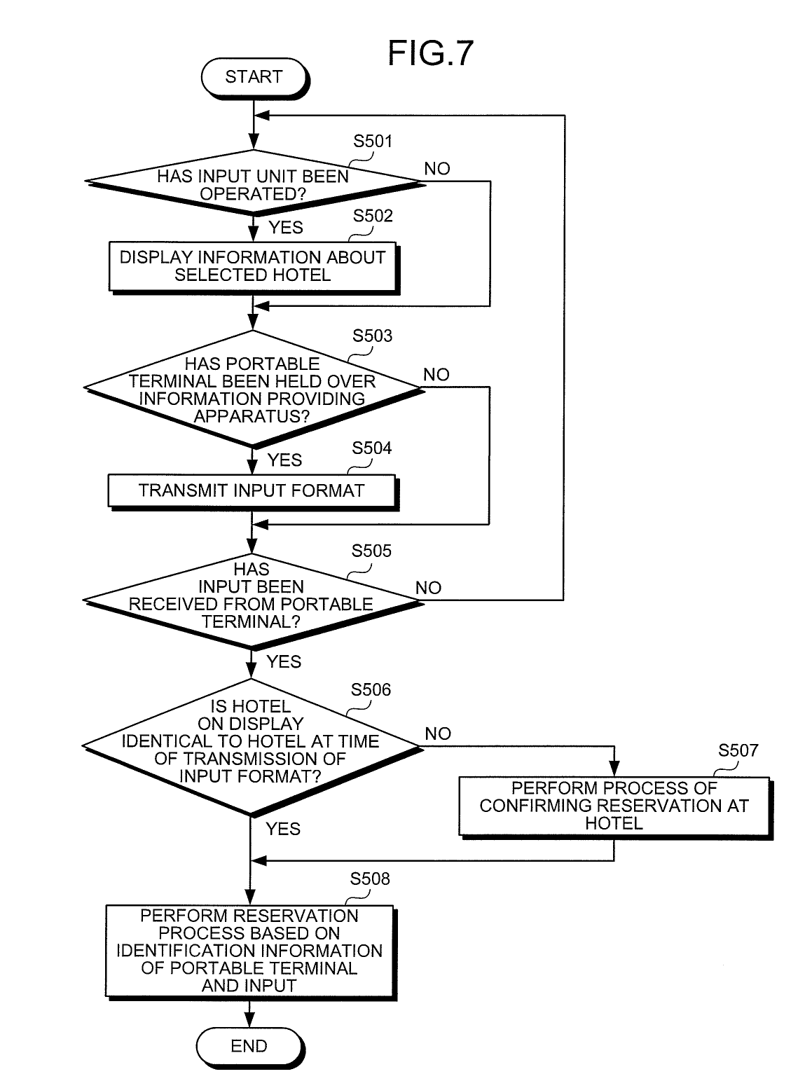

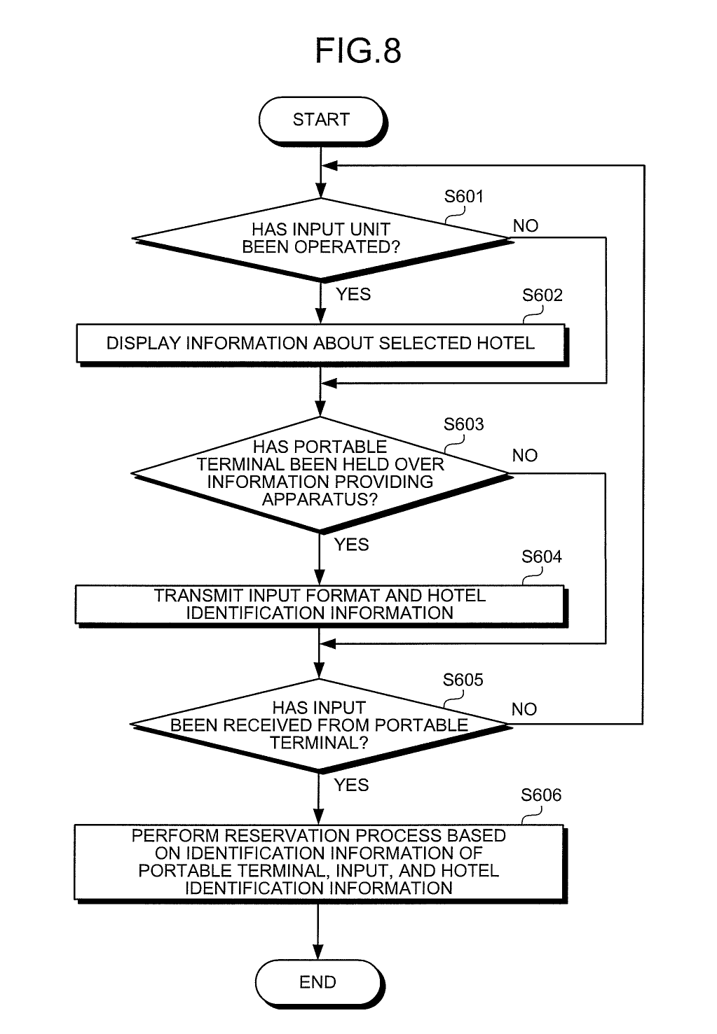

In the process of FIG. 6, from when the user selects an accommodation facility to when the input results are received from the portable terminal 2, no interrupt by another user is assumed. FIGS. 7 and 8 illustrate examples of the operation of the information providing apparatus in consideration of the occurrence of an interrupt by another user.

In FIG. 7, the information providing apparatus 1 first determines whether the input unit 12 has been operated (Step S501). If the input unit 12 has been operated (Yes at Step S501), the information providing apparatus 1 displays detailed information about a hotel (accommodation facility) selected through the operation (Step S502).

The information providing apparatus 1 also determines whether the portable terminal 2 has been held thereover (Step S503). If the portable terminal 2 has been held thereover (Yes at Step S503), the information providing apparatus 1 transmits an input format to the portable terminal 2 (Step S504).

If identification information and input information have been received from the portable terminal (Yes at Step S505), the information providing apparatus 1 determines whether the accommodation facility whose detailed information is now on display is identical to that at the time of transmitting the input format (Step S506).

As a result, if the accommodation facility whose detailed information is now on display is identical to that at the time of transmitting the input format (Yes at Step S506), the flow directly proceeds to a reservation process performed based on the received identification information and the input information (Step S508), and the process ends.

On the other hand, if the accommodation facility whose detailed information is now on display is different from that at the time of transmitting the input format (No at Step S506), the information providing apparatus 1 performs a process of requesting the user to confirm the accommodation facility at which a reservation is to be made (Step S507), and then performs a reservation process (Step S508).

In FIG. 8, when the input format is transmitted, hotel identification information that identifies an accommodation facility on display at that time is also transmitted, and a reservation process is performed on that accommodation facility identified by the hotel identification information.

Specifically, the information providing apparatus 1 first determines whether the input unit 12 has been operated (Step S601). When the input unit 12 has been operated (Yes at Step S601), the information providing apparatus 1 displays detailed information about the hotel (accommodation facility) selected through the operation (Step S602).

The information providing apparatus 1 also determines whether the portable terminal 2 has been held thereover (Step S603). If the portable terminal 2 has been held thereover (Yes at Step S603), the information providing apparatus 1 transmits, to the portable terminal 2, the input format and identification information of the hotel selected at that time (Step S604).

Upon receiving the identification information, input information and the hotel identification information from the portable terminal (Yes at Step S605), the information providing apparatus 1 performs a reservation process on the accommodation facility identified by the hotel identification information based on the received identification information of the portable terminal and input information (Step S606), and the process ends.

In this manner, when the hotel identification information is used, a reservation process can be performed without interruption by another user, and a different reservation format can be used for each accommodation facility.

The method of providing an input format can be changed as appropriate. For example, the information providing apparatus 1 may transmit an input format if no input information is present in the portable terminal when the user holds the portable terminal over the information providing apparatus 1 and, after input is provided, receive the input.

In another input aspect on the portable terminal side, an application program for inputting information required for reservation, for example, may be installed in advance on the portable terminal 2. This application program for input may be manually launched by the user as required. Alternatively, the information providing apparatus 1 can be configured to transmit to the portable terminal 2 a signal for requesting to launch the application program, i.e., requesting the portable terminal 2 to enter the wait state for receiving input from the user.

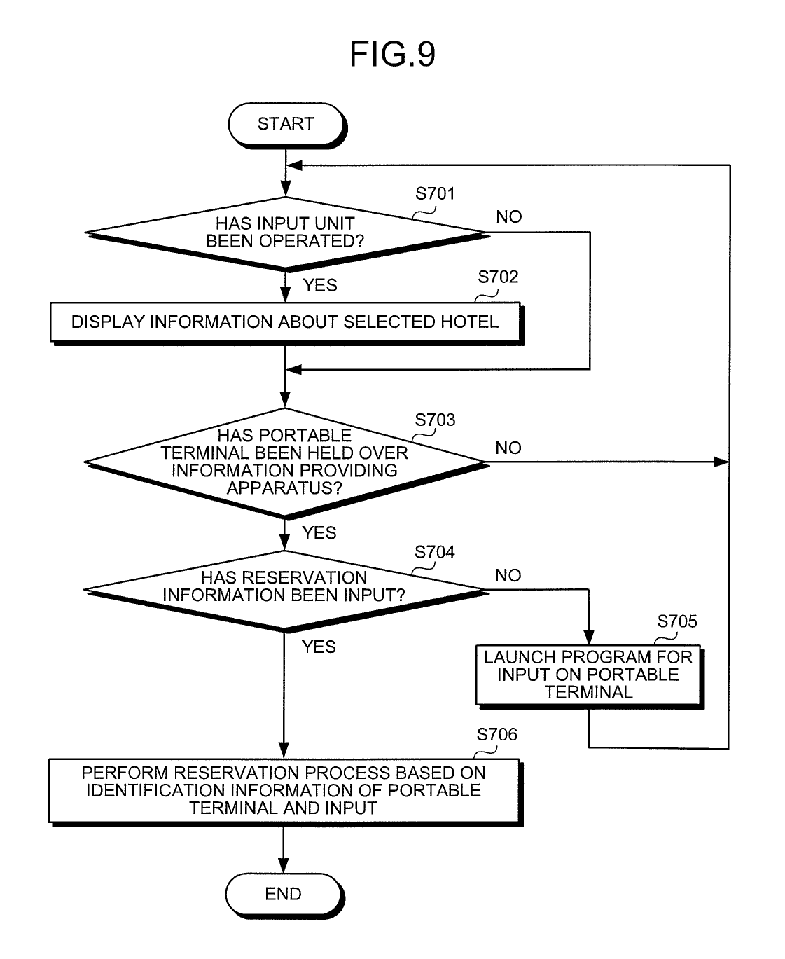

FIG. 9 is a flowchart of the operation of the information providing apparatus 1 in this case. In FIG. 9, the information providing apparatus 1 first determines whether the input unit 12 has been operated (Step S701). If the input unit 12 has been operated (Yes at Step S701), the information providing apparatus 1 displays detailed information about a hotel (accommodation facility) selected through the operation (Step S702).

The information providing apparatus 1 then determines whether the portable terminal 2 has been held thereover (Step S703). If the portable terminal 2 has been held thereover (Yes at Step S703), the information providing apparatus 1 further determines whether information required for reservation has been input to the portable terminal 2 (Step S704).

If information required for reservation has not been input (No at Step S704), the program for input installed on the portable terminal 2 is launched to make a transition to a state of waiting for an input from the user (Step S705).

On the other hand, if information required for reservation has been input to the portable terminal 2 (Yes at Step S704), the information providing apparatus 1 reads the input information and the identification information to perform a process of making a reservation at the accommodation facility (Step S705), and the process ends.

In this manner, with the user transmitting information input to the portable terminal 2 to the information providing apparatus 1, the information providing apparatus can provide sophisticated services, such as a reservation for accommodation. Also, if the information required at the time of a reservation for accommodation, such as the user's name and address, is set in advance in the portable terminal 2, such information can be read and transmitted, thereby further simplifying the input operation by the user.

The information providing system is described above as providing information about accommodation facilities and performing a reservation process by way of example. The present invention is not restricted to this, but can be used for providing any information.

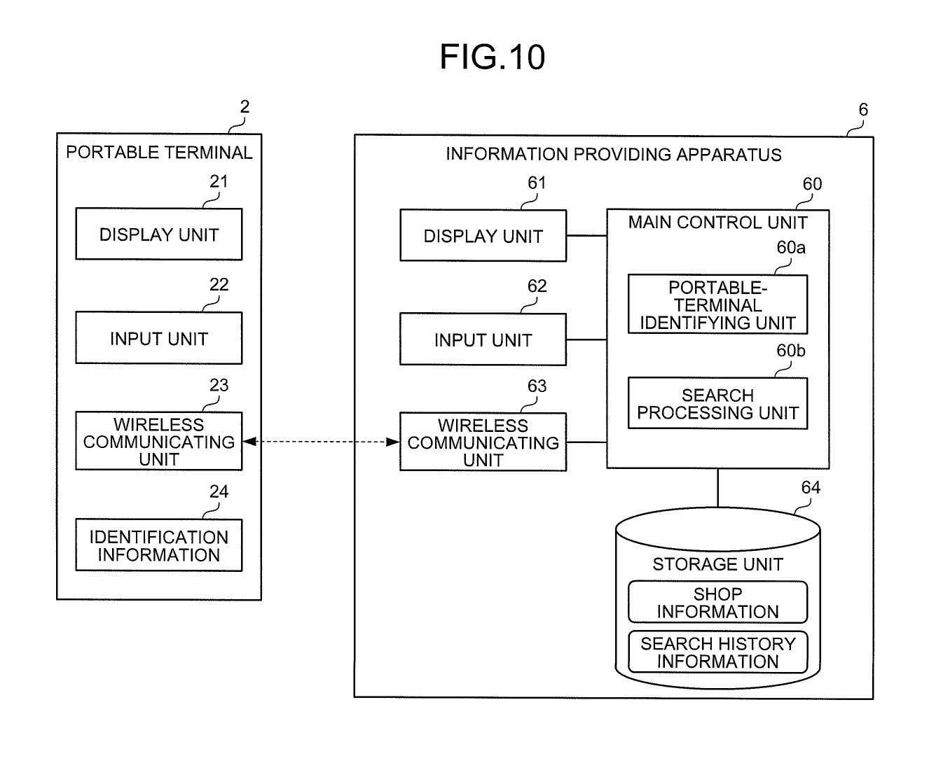

FIG. 10 is a schematic block diagram of an information providing system that provides information about shops and goods at a facility, such as a shopping mall with a plurality of shops. As depicted in FIG. 10, this information providing system includes the portable terminal 2 and an information providing apparatus 6.

The portable terminal 2 is similar to that depicted in FIG. 1. The information providing apparatus 6 includes a display unit 61, which can be implemented by, for example, a liquid-crystal display, a plasma-display, or a projector, and an input unit 62, which is implemented by, for example, a touch panel. A wireless communicating unit 63 is an IC-tag reader communicating with the wireless communicating unit 23 of the portable terminal 2 to read information input by the user and the identification information 24.

A storage unit 64 stores therein information about shops and goods and information about search history of the user. A main control unit 60 controls the overall operation of the information providing apparatus 6, such as changing the display contents of the display unit 61 based on input received by the input unit 62, and includes a portable-terminal identifying unit 60a and a search processing unit 60b.

The portable-terminal identifying unit 60a obtains the identification information 24 of the portable terminal held over the wireless communicating unit 63 to identify the portable terminal. The search processing unit 60b performs a search process on a designated genre by using information required for a search received by the wireless communicating unit 63 from the portable terminal 2 and the identification result from the portable-terminal identifying unit 10.

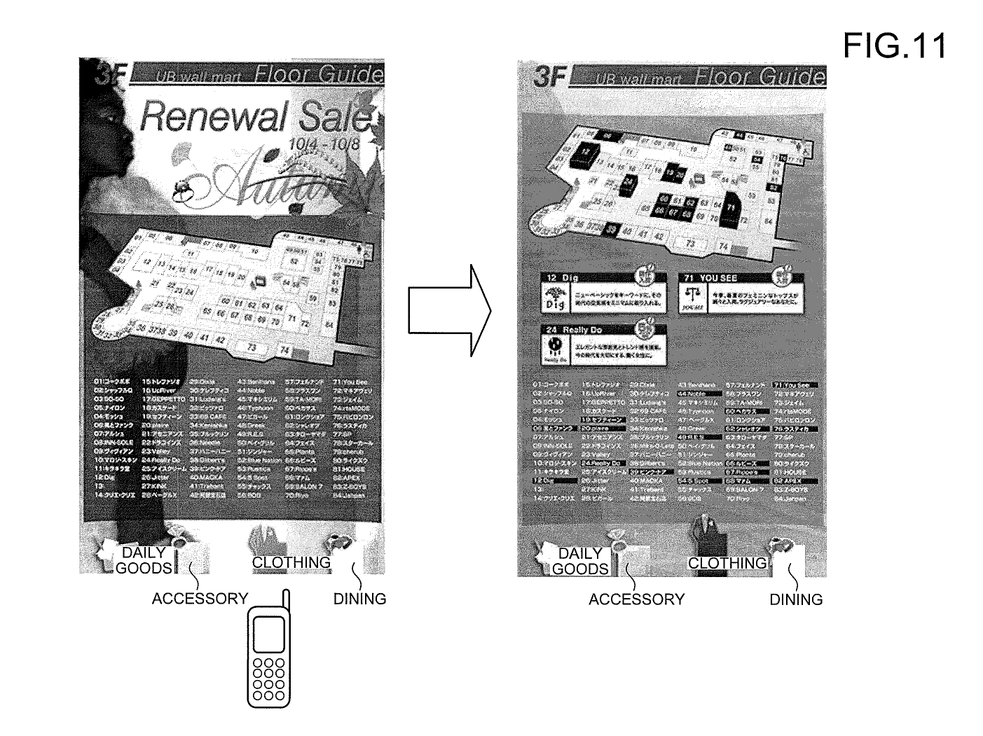

With reference to FIG. 11, a specific example of information provided by the information providing apparatus 6 is explained next. In FIG. 11, the information providing apparatus 6 displays a map of the inside of a shopping mall and the position of each shop.

On a lower portion of a display image, menu items, such as “Daily goods”, “Accessory”, “Clothing”, and “Dining”, are displayed correspondingly to the positions of IC-tag readers.

For example, when a user inputs a search keyword to the portable terminal 2 and holds the portable terminal 2 over the menu item “Clothing”, the information providing apparatus 6 searches for shops that offer clothes associated with the input search keyword and displays the search results.

This allows the user to designate a desired item name, brand name, or genre to easily find a desired item.

Besides, by obtaining the identification information 24 from the portable terminal 2, the information providing apparatus 6 can perform an information analysis as to which the user is interested in who is searching for shops. In this example, a search is performed on the basis of genre, such as “Daily goods”, “Accessory”, “Clothing”, and “Dining”. In another example, “Shop search”, “Product search”, and “Brand search” can be provided as menu items, and different search process can be made with an input search keyword.

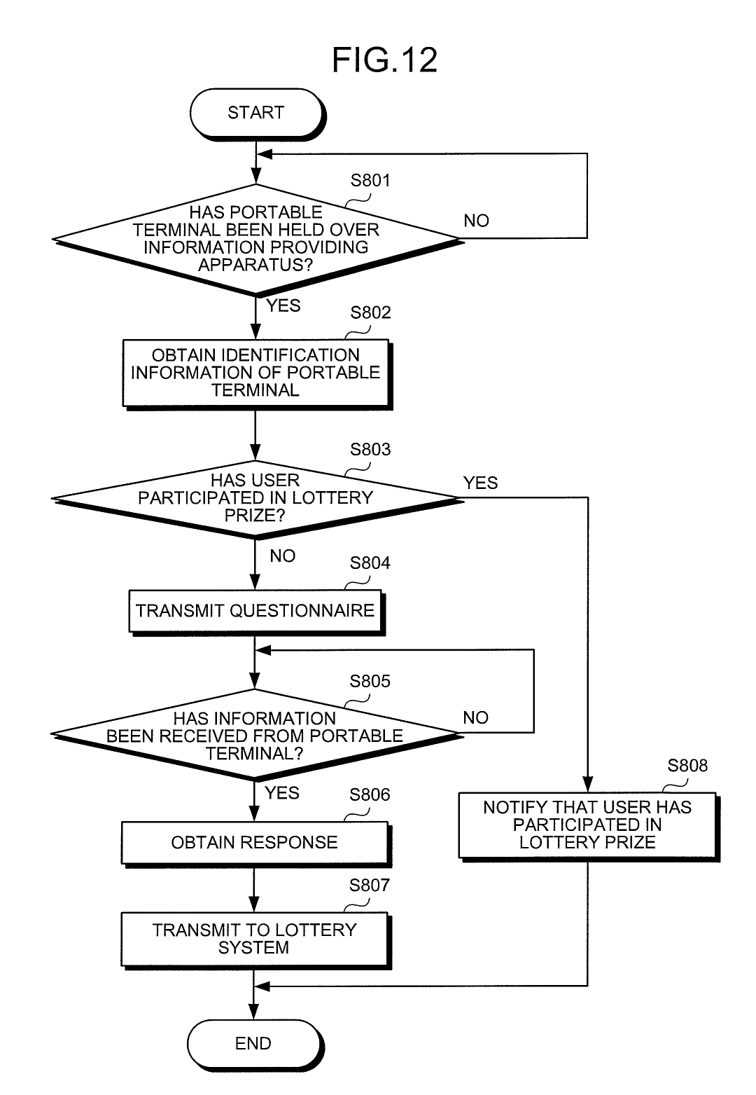

The information providing apparatus can also be applied to management of participation in a questionnaire, a prize competition, or a game. FIG. 12 is a flowchart of the operation of the information providing apparatus applied to a service in which a user can participate in a lottery for a desired item by responding to a questionnaire.

As depicted in FIG. 12, after receiving from the user input to select a desired item from a plurality of items, displays details of the selected item, the information providing apparatus 1 determines whether the portable terminal has been held thereover (Step S801). If the portable terminal has been held thereover (Yes at Step S801), the information providing apparatus 1 obtains identification information of the portable terminal (Step S802). Then, the information providing apparatus 1 determines, based on the obtained identification information, whether the user has participated in a lottery prize (Step S803). If the user has already participated in the lottery prize (Yes at Step S803), the information providing apparatus 1 notifies the user that the user has already participated in the lottery prize (Step S808), and the process ends.

If the user has not participated in the lottery prize (No at Step S803), the information providing apparatus 1 transmits a questionnaire to the portable terminal (Step S804) and, upon receipt of information from the portable terminal (Step S805), obtains a response to the questionnaire (Step S806). Then, the information providing apparatus 1 transmits the content about the application and the identification information to a lottery system (Step S807), and ends the process.

If a plurality of IC-tag readers that communicate with the portable terminal are provided and assigned different products, the user can select a product by holding the portable terminal over an IC-tag reader corresponding to the desired product, thereby making an application for a specific product without selecting the product through an input unit such as a touch panel.

As described above, in the information providing system according to the present embodiments, the user P1 inputs information required for a reservation process to the portable terminal 2, and the information is then transmitted from the portable terminal 2 to the information providing apparatus 1 through short-distance wireless communication. The information providing apparatus 1 collectively receives the information required for a reservation process. Thus, it is possible to provide information to an indefinite number of users, improve convenience, simplify an input operation, and provide sophisticated services.

As set forth hereinabove, according to an embodiment of the present invention, information can be provided to an indefinite number of users. In addition, information input from a user can be collectively received and, based on the information, a specific process can be performed in a simple manner.

Moreover, it is possible to simplify input operation by the user. Thus, the user can select a menu item and transmit input information in a simple manner.

Furthermore, information can be provided about accommodation facilities, shops, restaurants, or the like, to an indefinite number of users. Besides, an accommodation-facility, a shop, or the like can be searched and reserved based on input information required for such services collectively received from a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information providing apparatus comprising:
a display unit that displays a predetermined menu item;
a process performing unit that performs a predetermined process corresponding to the menu item; and
a wireless communicating unit that includes a reader unit corresponding to the menu item, the reader unit receiving, from a portable terminal that has received input information necessary for the predetermined process and is brought near the reader unit, the input information together with identification information that identifies a user or the portable terminal through short-distance wireless communication, wherein
the process performing unit performs the predetermined process based on the identification information and the input information.

2. The information providing apparatus according to claim 1, wherein
the reader unit includes a plurality of readers each corresponding to a menu item, and
when one of the readers receives, from the portable terminal that is brought near the reader, the input information together with the identification information through short-distance wireless communication, the process performing unit performs a predetermined process corresponding to the menu item.

3. The information providing apparatus according to claim 1, wherein the display unit further displays information about the predetermined process.

4. The information providing apparatus according to claim 1, wherein the predetermined process is a process of making a reservation at or searching for an accommodation facility, a shop or a restaurant.

5. The information providing apparatus according to claim 1, wherein, when the portable terminal is brought near the reader unit, the wireless communicating unit transmits, to the portable terminal, input format data used to provide the input information to the portable terminal.

6. The information providing apparatus according to claim 1, wherein, when the portable terminal is brought near the reader unit before receiving the input information, the wireless communicating unit transmits, to the portable, terminal, input format data used to provide the input information to the portable terminal.

7. The information providing apparatus according to claim 1, wherein the wireless communicating unit transmits to the portable terminal a signal for requesting to enter wait state for receiving information.

8. An information providing apparatus comprising:
a display unit that displays a predetermined menu item;
a connecting unit that establishes a connection to an external server including a process performing unit that performs a predetermined process corresponding to the menu item; and
a wireless communicating unit that includes a reader unit corresponding to the menu item, the reader unit receiving, from a portable terminal that has received input information necessary for the predetermined process and is brought near the reader unit, the input information together with identification information that identifies a user or the portable terminal through short-distance wireless communication, wherein
the connecting unit transmits the identification information and the input information to the external server to cause the process performing unit to perform the predetermined process.

9. The information providing apparatus according to claim 8, wherein
the reader unit includes a plurality of readers each corresponding to a menu item, and
when one of the readers receives, from the portable terminal that is brought near the reader, the input information together with the identification information through short-distance wireless communication, the process performing unit performs a predetermined process corresponding to the menu item.

10. The information providing apparatus according to claim 8, wherein the display unit further displays information about the predetermined process.

11. The information providing apparatus according to claim 8, wherein the predetermined process is a process of making a reservation at or searching for an accommodation facility, a shop or a restaurant.

12. The information providing apparatus according to claim 8, wherein, when the portable terminal is brought near the reader unit, the wireless communicating unit transmits, to the portable terminal, input format data used to provide the input information to the portable terminal.

13. The information providing apparatus according to claim 8, wherein, when the portable terminal is brought near the reader unit before receiving the input information, the wireless communicating unit transmits, to the portable terminal, input format data used to provide the input information to the portable terminal.

14. The information providing apparatus according to claim 8, wherein the wireless communicating unit transmits to the portable terminal a signal for requesting to enter wait state for receiving information.

15. An information providing method comprising:
displaying a predetermined menu item;
performing a predetermined process corresponding to the menu item; and
communicating via a reader unit corresponding to the menu item with a portable terminal through short-distance wireless communication, the reader unit receiving, from the portable terminal that has received input information necessary for the predetermined process and is brought near the reader unit, the input information together with identification information that identifies a user or the portable terminal, wherein
the predetermined process is performed based on the identification information and the input information.

16. An information providing method comprising:
displaying a predetermined menu item;
establishing a connection to an external server including a process performing unit that performs a predetermined process corresponding to the menu item; and
communicating via a reader unit corresponding to the menu item with a portable terminal through short-distance wireless communication, the reader unit receiving, from the portable terminal that has received input information necessary for the predetermined process and is brought near the reader unit, the input information together with identification information that identifies a user or the portable terminal, wherein
the connecting includes transmitting the identification information and the input information to the external server to cause the process performing unit to perform the predetermined process.

17. A computer-readable recording medium that stores therein a computer program that causes a computer to perform:
displaying a predetermined menu item;
performing a predetermined process corresponding to the menu item; and
communicating via a reader unit corresponding to the menu item with a portable terminal through short-distance wireless communication, the reader unit receiving, from the portable terminal that has received input information necessary for the predetermined process and is brought near the reader unit, the input information together with identification information that identifies a user or the portable terminal, wherein
the predetermined process is performed based on the identification information and the input information.

18. A computer-readable recording medium that stores therein a computer program that causes a computer to perform:
displaying a predetermined menu item;
establishing a connection to an external server including a process performing unit that performs a predetermined process corresponding to the menu item; and
communicating via a reader unit corresponding to the menu item with a portable terminal through short-distance wireless communication, the reader unit receiving, from the portable terminal that has received input information necessary for the predetermined process and is brought near the reader unit, the input information together with identification information that identifies a user or the portable terminal, wherein
the connecting includes transmitting the identification information and the input information to the external server to cause the process performing unit to perform the predetermined process.
